(19) United States
(12) Patent Application Publication
(10) Pub. No.: US 2019/0027307 A1
(43) Pub. Date: Jan. 24, 2019

(54) METHOD OF WINDING A STATOR CORE TO PREVENT BREAKAGE OF WIRE BETWEEN PIN AND WINDING GROOVE

(71) Applicant: WEN LIANG WANG, Kaohsiung City (TW)

(72) Inventor: WEN LIANG WANG, Kaohsiung City (TW)

(21) Appl. No.: 15/859,939

(22) Filed: Jan. 2, 2018

Related U.S. Application Data
(60) Provisional application No. 62/533,698, filed on Jul. 18, 2017.

(51) Int. Cl. H01F 41/076; H02K 3/28; H02K 15/04; H02K 1/14; H01F 41/096; H01F 41/071; H02K 3/52

(52) U.S. Cl. CPC H01F 41/076; H02K 3/28; H02K 15/0428; H02K 3/521; H02K 15/0435; H01F 41/096; H01F 41/071; H02K 1/14

(57) ABSTRACT

To prevent breakage of the segment of an enameled wire that extends between a pin and a winding groove on an insulating stator base, a tension servo of an automatic wire-winding machine in controlled to first wind the enameled wire tightly around the pin of the insulating stator base and then to loosely wind the enameled wire around the pin to form at least one loose winding with a gap between the enameled wire and the pin. The enameled wire is then drawn into the winding groove of the stator base and tightly wound around the stator core within the winding groove. Optionally at least one first loose winding with a gap between the enameled wire and a bottom of the winding groove may initially be formed before tightly winding additional windings within the winding groove.

This application claims the benefit of provisional U.S. Patent Application No. 62/533,698, filed Jul. 18, 2017, and incorporated herein by reference.

### FIELD OF THE PRESENT INVENTION

The present invention relates to brushless DC motors (BLDCs), and more particularly to a method for preventing enameled wire between a pin and winding grooves on an insulating stator base from breakage by controlling a tension servo of an automatic wire-winding machine to first wind the enameled wire tightly around the pin of the insulating stator base, and subsequently to add a loose winding in which the enameled wire is wound loosely around the pin to form a gap with the pin, before drawing the enameled wire into the winding groove of the insulating stator base to form windings that tightly encircle the insulating stator base. As a result of the added loose winding, when forming layered wire windings in the winding groove, the enameled wire segment between the pin and the winding groove is prevented from over-tension and breakage caused by bending of the wire as it enters the groove and/or as a result of engagement of the wire with edges of a Hall sensor printed circuit board (PCB) fixing hole. In addition to forming a loose winding around the pin, an optional loose first winding may also be formed within the winding groove, before the remaining windings are tightly wound to complete the winding process.

### BACKGROUND OF THE INVENTION

As shown in FIGS. 1 and 2, a conventional stator coil 10 of a brushless DC motor is formed by winding enameled wire W into layers in each winding groove 12 of an insulating stator base 11 using an automatic wire-winding machine. For fixing the windings, a pin 13 for each winding groove 12 is respectively provided at a top of the stator base 11. To begin forming windings, the tension servo of the automatic wire-winding machine feeds enameled wire W into a winding die of the automatic wire-winding machine through a hanger. Then a clamp on the winding die holds the enameled wire W and leads it to form wire windings that tightly encircle the pins 13 of the insulating stator base 11. Afterward, the enameled wire W is drawn into the winding groove 12 of the insulating stator base 11 and caused to tightly encircle the winding groove 12. The winding continues so that the enameled wire W forms layers of windings that tightly encircle each other in the winding groove 12. This process is repeated so that each winding groove 12 is filled by the layered windings of the enameled wire W, thereby finalizing the production of the stator coil 10.

Referring to FIGS. 3 and 4, after the enameled wire W has tightly encircled the pin 13 of the insulating stator base 11, and been drawn into the winding groove 12 of the insulating stator base 11 for tight encirclement, the enameled wire segment W1 between the pin 13 and the winding groove 12 of the insulating base 11 abuts against the upper rim 110 of the insulating base 11 and bends as shown in FIG. 3. As the number of layers of tightened windings of the enameled wire W in the winding groove 12 increases, as shown in FIG. 4, the bend of the enameled wire segment W1 between the pin 13 and the winding groove 12 on the insulating base 11 is subjected to a continuous tension. In the event that tension setting of the tension servo of the automatic wire-winding machine is excessive, the bent enameled wire segment W1 is likely to break, causing a 0.5% defect rate if stator winding products made by existing mass manufacturing processes. Even when the tension setting of the tension servo of the automatic wire-winding machine is not excessive, so that the bent enameled wire segment W1 does not break immediately, when the stator coil 10 is assembled into a brushless DC motor and undergoes a period of electrified use, it tends to break because of the heat generated when current passes through the bend, and consequently renders the entire brushless DC motor inoperative.

Referring to FIGS. 5 and 6, the stator coil 10 formed by filling each winding groove with layered windings of the enameled wire W is assembled with a Hall sensor's printed circuit board (PCB) 20. The PCB 20 is provided with fixing holes 21 corresponding to the pins 13 of the stator coil 10 in terms of both amount and position. To assemble the two, each fixing hole 21 of the PCT 20 receives a pin 13 of the stator coil 10, and an automatic soldering machine fastens the fixing holes 21 and the pins 13 by soldering. When the pins 13 of the stator winding 10 enter the fixing holes 21 of the PCB 20, the edges of the fixing holes 21 can touch the enameled wire segments W1 between the pins 13 and the winding grooves 12 of the insulating base 11 as is apparent in the enlarged view of FIG. 6, causing the enameled wire segment W1 to be further bent and over-tensioned. This is another reason that breakage of the enameled wire segment W1 can occur. As a result, the need to prevent the enameled wire segment between the pin and the winding groove of the insulating base from breakage is a pressing issue for manufacturers of stator coil products to address.

### SUMMARY OF THE INVENTION

One objective of the present invention is to provide a method for preventing enameled wire between a pin and a winding groove on an insulating stator base from breakage, which comprises controlling a tension servo of an automatic wire-winding machine to first wind the enameled wire tightly around the pin of the insulating stator base, and then to wind the enameled wire loosely around the pin to form at least one loose winding that forms a gap with the pin. After forming the added loose winding, the enameled wire can be drawn into the winding groove of the insulating stator base to form layered windings within the winding groove that tightly encircle the insulating stator coil without subjecting the enameled wire segment between the pin and the winding groove to risks of over-tension and breakage.

Another objective the present invention is to provide a method for preventing enameled wire between a pin and a winding groove on an insulating stator base from breakage, which comprises controlling a tension servo of an automatic wire-winding machine to first wind the enameled wire tightly around the pin of the insulating stator base, and then to wind the enameled wire loosely around the pin to form at least one loose winding that forms a gap with the pin, followed by drawing of the enameled wire into the winding groove of the insulating stator base to form windings that tightly encircle the insulating stator core. Consequently, when the fixing hole of the Hall sensor's PCB receives the stator winding's pin, and an edge of a fixing hole in the PCB touches the enameled wire segment between the pin and the winding groove on the insulating base, the gap formed by at least one loosened winding around the pin provides a margin to compensate for possible over-tension caused by compression, preventing wire breakage.

In addition to forming a first tight winding and a second loose winding around the stator winding's pin, a first loose winding may be formed after drawing the enameled wire into the winding groove, before forming the remaining winding layers by tightly winding the enameled wire around the insulating stator coil.

### BRIEF DESCRIPTION OF THE DRAWINGS

FIG. 1 is a perspective view of a conventional stator winding.

FIG. 2 is a cross-sectional view taken along Line 2-2 of FIG. 1.

FIG. 3 is an enlarged view of Part A of FIG. 2.

FIG. 4 schematically shows bends of the enameled wire segment between the pin and the winding groove on the insulating base of FIG. 3.

FIG. 5 is a cutaway view of the conventional stator winding and a Hall sensor's PCB.

FIG. 6 is cross-sectional view of the assembled stator winding and PCB of FIG. 5.

FIG. 7 is a schematic drawing illustrating a first embodiment of the present invention.

FIG. 8 is a schematic drawing illustrating a second embodiment of the present invention.

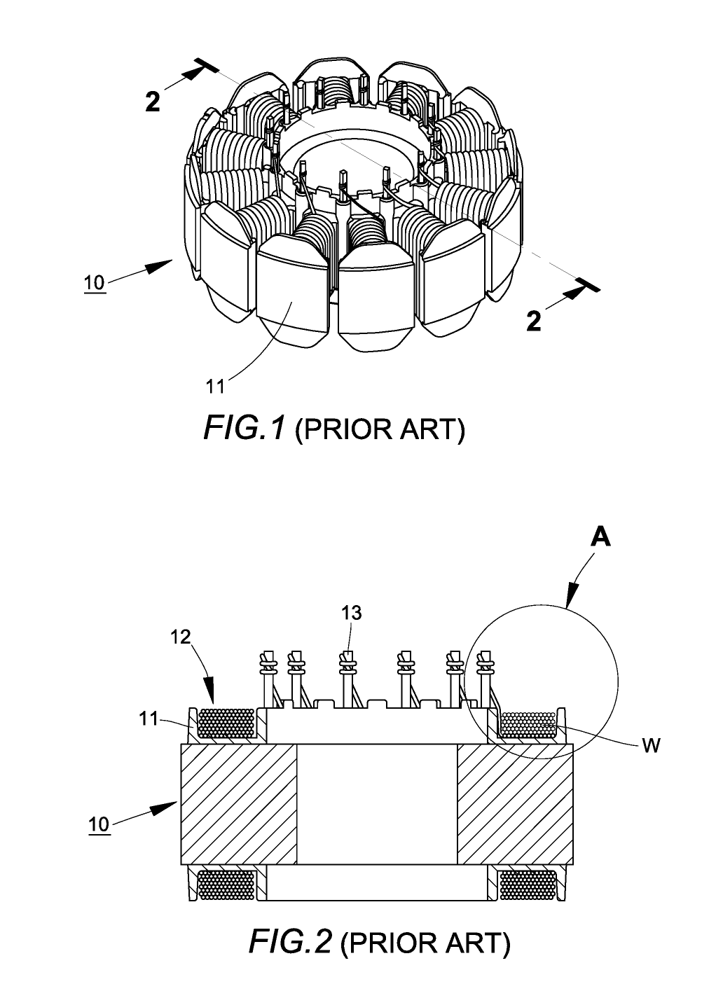

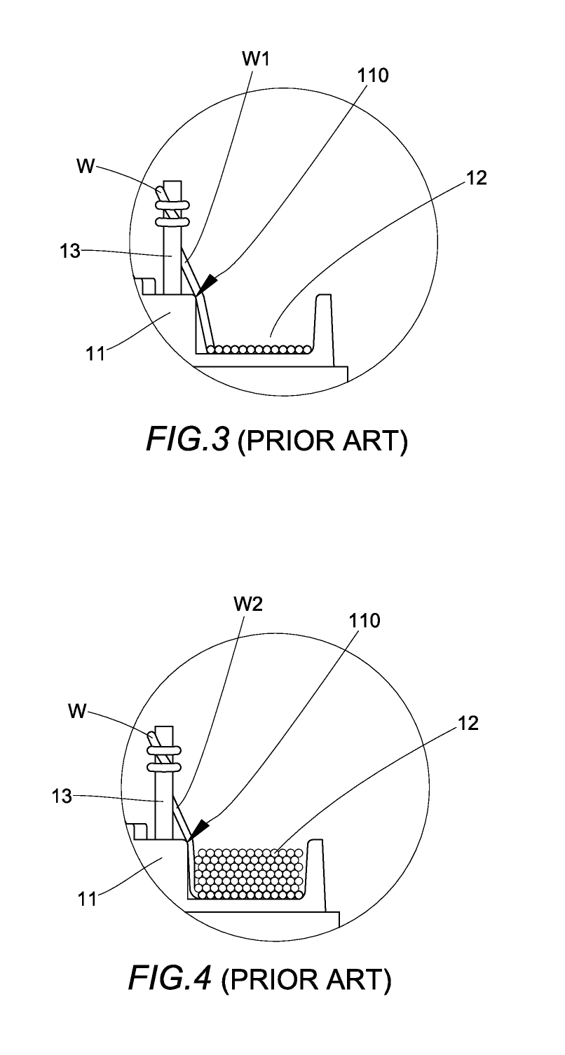

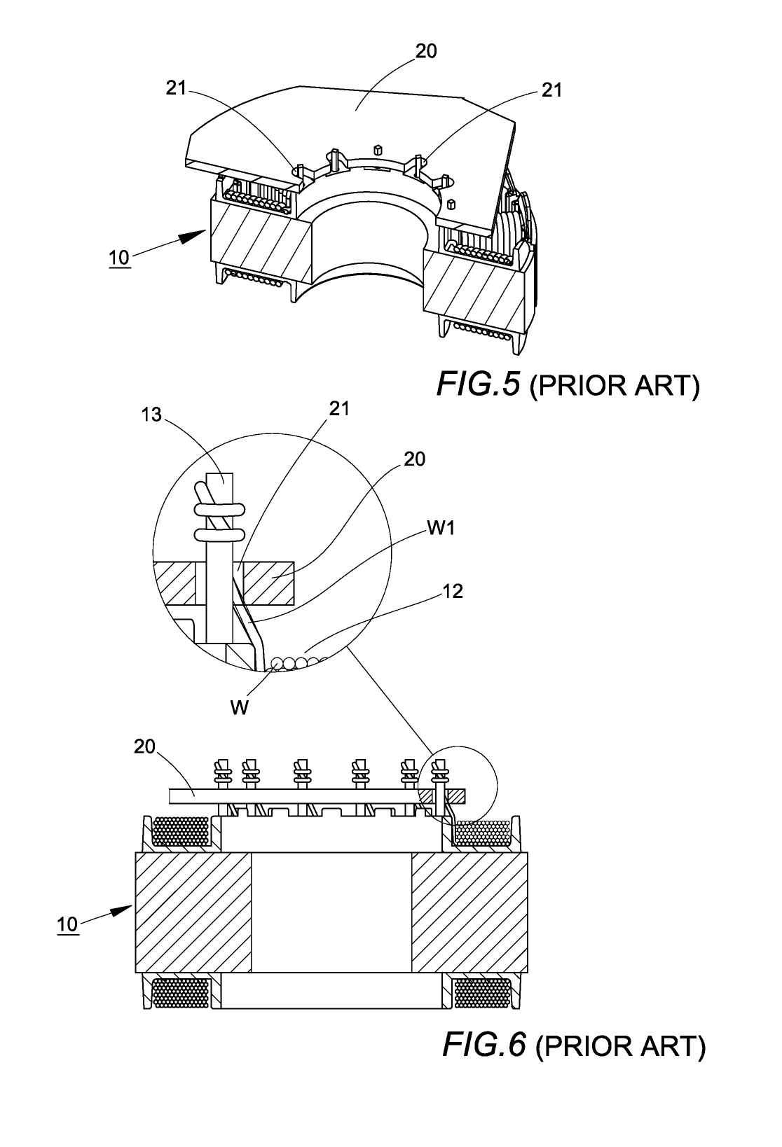

### DETAILED DESCRIPTION OF THE PREFERRED EMBODIMENTS

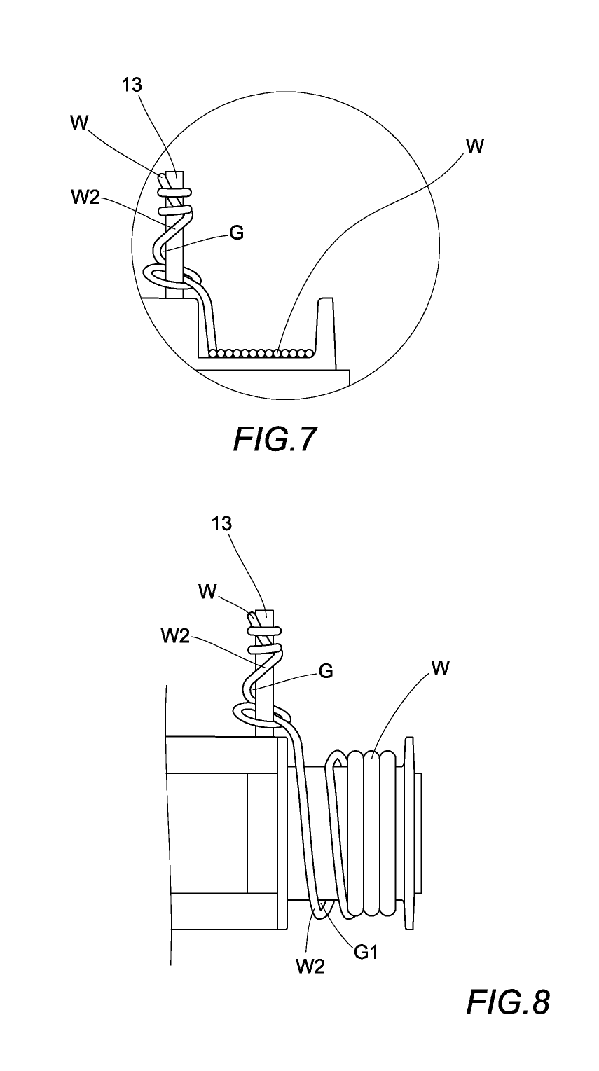

FIG. 7 shows a first embodiment of a method for preventing enameled wire between a pin and a winding groove on an insulating stator base from breakage. The method comprises controlling a tension servo of an automatic wire-winding machine to first wind the enameled wire W tightly around the pin 13 of the insulating stator base 11, then to wind the enameled wire W around the pin 13 to form at least one winding that loosely encircles the pin 13 so that the loose winding forms a gap G with the pin 13, and afterward to draw the enameled wire W into the winding groove 12 of the insulating stator base 11 to form windings that tightly encircle the insulating stator base 11 within the groove 12. Consequently, in the process where the enameled wire W forms layers of windings in the winding groove 12, the enameled wire segment W2 between the pin 13 and the winding groove 12 with the gap G formed by the at least one loose winding provides a margin that compensates for the compression that would otherwise be caused by bending of the enameled wire W as it enters the winding groove 12, so that the enameled wire segment W2 between the pin 13 and the winding groove 12 is not over-tensioned at all, and eliminating the risk of breakage.

FIG. 8 shows a second embodiment of a method for preventing enameled wire between a pin and a winding groove on an insulating stator base from breakage. The method comprises controlling a tension servo of an automatic wire-winding machine to first wind the enameled wire W tightly around the pin 13 of the insulating stator base 11, and then wind the enameled wire W around the pin 13 to form at least one winding that loosely encircles the pin 13 to form a gap G between the enameled wire W and the pin 13. After forming the loose winding, the enameled wire W is drawn into the winding groove 12 of the insulating stator base 11 to form a first loose winding that forms a gap G1 with a bottom of the winding groove 12, and then to successively form windings that tightly encircle the insulating stator base 11. As a result, in the process where the enameled wire W forms layers of windings in the winding groove 12, the enameled wire segment W2 between the pin 13 and the winding groove 12, which extends between the gap G formed by the at least one winding around the pin 13 and the gap G1 formed by the at least one loose winding around the winding groove 12, provides a margin that compensates for the compression that would otherwise be caused by bending of the enameled wire W as it enters the winding groove 12, so that the enameled wire segment W2 between the pin 13 and the winding groove 12 is not over-tensioned at all, eliminating the risk of breakage.

To sum up, the present invention can eliminate the bends in the enameled wire segment between the pin and the winding groove that are seen in the conventional insulating base, and achieve a defect-free rate as high as 100%, in contrast to the 0.5% defect rate of stator winding products made by existing mass manufacturing processes, making the present industrially usable and practical.

What is claimed is:

1. A method for preventing enameled wire extending between a pin and a winding groove on an insulating stator base from breakage, comprising controlling a tension servo of an automatic wire-winding machine to:
first winding the enameled wire tightly around the pin of the insulating stator base;
after first winding the enameled wire tightly around the pin of the insulating stator base, loosely winding the enameled wire around the pin to form at least one loose winding with a gap between the loose winding and the pin;
after loosely winding the enameled wire around the pin, drawing the enameled wire into the winding groove of the insulating stator base to form windings that tightly encircle the stator base within the winding groove.

2. A method for preventing enameled wire between a pin and a winding groove on an insulating stator base from breakage, comprising controlling a tension servo of an automatic wire-winding machine to:
first winding the enameled wire tightly around the pin of the insulating stator base;
after first winding the enameled wire tightly around the pin of the insulating stator base, loosely winding the enameled wire around the pin to form at least one loose winding with a gap between the enameled wire and the pin;
after loosely winding the enameled wire around the pin, drawing the enameled wire into the winding groove of the stator base and loosely winding the enameled wire around the stator base within the winding groove to form at least one loose winding with a second gap between the enameled wire and a bottom of the winding groove;
after loosely winding the enameled wire around the stator base within the winding groove to form the first loose winding, tightly winding the enameled wire around the stator base within the winding groove to form subsequent tightly-wound windings.
